(19) United States
(12) Patent Application Publication
(10) Pub. No.: US 2023/0253832 A1
(43) Pub. Date: Aug. 10, 2023

(54) ELECTRONIC DEVICE

(71) Applicant: TOYODA GOSEI CO., LTD., Kiyosu-shi (JP)

(72) Inventors: Atsushi SUGIHARA, Kiyosu-shi (JP); Shinichiro FUKI, Kiyosu-shi (JP); Yuki TOKUYAMA, Kiyosu-shi (JP); Ryo OSAWA, Kiyosu-shi (JP); Kazuhito KAWAMURA, Kiyosu-shi (JP)

(21) Appl. No.: 18/158,765

(22) Filed: Jan. 24, 2023

(30) Foreign Application Priority Data
Feb. 7, 2022 (JP) 2022-017312

(51) Int. Cl. H02J 50/20; H02J 7/00

(52) U.S. Cl. CPC H02J 50/20; H02J 7/0048

(57) ABSTRACT

An electronic device includes a power receiving device, a reception-side power storage unit configured to store power received by the power receiving device, a drive unit configured to be activated together with the power receiving device by the power stored in the reception-side power storage unit, a notification unit configured to notify a user of a state of the power in the reception-side power storage unit, a first power measurement unit configured to measure supplied power, a second power measurement unit configured to measure power consumption, and circuitry configured to change a notification mode in the notification unit based on a relationship between the supplied power and the power consumption.

### BACKGROUND

### 1. Field

The present disclosure relates to an electronic device that is activated by the power transmitted from a power transmitting device through contactless power supply using a power transfer signal.

### 2. Description of Related Art

A typical contactless power supply system performs contactless power supply using a power transfer signal from a power transmitting device to a power receiving device. The electronic device having this system includes the power receiving device, a reception-side power storage unit, and a drive unit. The power receiving device receives power transmitted from the power transmitting device through contactless power supply. The reception-side power storage unit stores the power received by the power receiving device. The drive unit is activated together with the power receiving device by the power stored in the reception-side power storage unit. The electronic device allows the reception-side power storage unit to store power even when the device is located at a position separated from the power transmitting device. Thus, the electronic device can be freely moved.

As the electronic device becomes farther from the power transmitting device, the amount of power supplied to the reception-side power storage unit becomes smaller due to a space transfer loss. Thus, a user of the electronic device needs to place the electronic device within a power transmissible region of the power transmitting device in order to perform contactless power supply to the power receiving device.

However, the user is unable to see a power transfer signal (radio wave) transmitted from the power transmitting device and thus cannot visually check the power transmissible region of the power transmitting device. Thus, the electronic device may potentially be moved beyond the power transmissible region. As a result, the power supplied to the reception-side power storage unit will decrease. In an extreme case, supplied power, which refers to the power supplied from the reception-side power storage unit to the power receiving device and the drive unit, is more likely to become 0 so that the reception-side power storage unit and the drive unit stop unintentionally (unknowingly).

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An electronic device that solves the above problem includes a power receiving device configured to receive power transmitted from a power transmitting device through contactless power supply using a power transfer signal, a reception-side power storage unit configured to store the power received by the power receiving device, a drive unit configured to be activated together with the power receiving device by the power stored in the reception-side power storage unit, a notification unit configured to notify a user of a state of the power in the reception-side power storage unit, a first power measurement unit configured to measure supplied power, the supplied power referring to power suppliable from the reception-side power storage unit to the power receiving device and the drive unit, a second power measurement unit configured to measure power consumption, the power consumption referring to power consumed by the power receiving device and the drive unit, and circuitry configured to change a notification mode in the notification unit based on a relationship between the supplied power measured by the first power measurement unit and the power consumption measured by the second power measurement unit.

Other features and aspects will be apparent from the following detailed description, the drawings, and the claims.

### BRIEF DESCRIPTION OF DRAWINGS

FIG. 1 is a diagram of an electronic device according to a first embodiment, schematically showing a contactless power supply system.

FIG. 2 is a flowchart illustrating a notification mode changing routine executed by the notification controlling unit in the first embodiment.

FIG. 3A is a diagram of the electronic device according to a second embodiment, illustrating an indicator shown in a first display mode.

FIG. 3B is a diagram of the electronic device according to the second embodiment, illustrating the indicator shown in a second display mode.

FIG. 4 is a flowchart illustrating the notification mode changing routine executed by the notification controlling unit in the second embodiment.

FIG. 5A is a diagram illustrating a modification of the first display mode shown by the indicator of the second embodiment.

FIG. 5B is a diagram illustrating a modification of the second display mode shown by the indicator of the second embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### First Embodiment

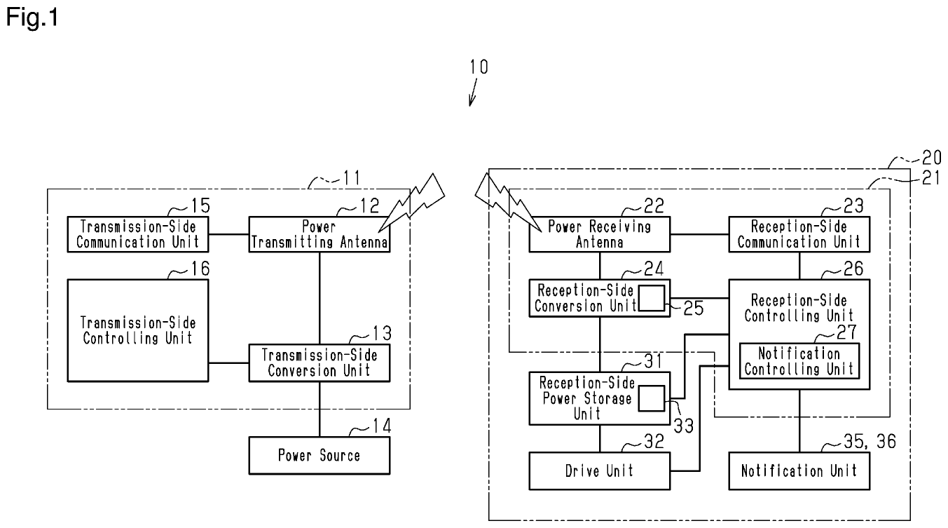

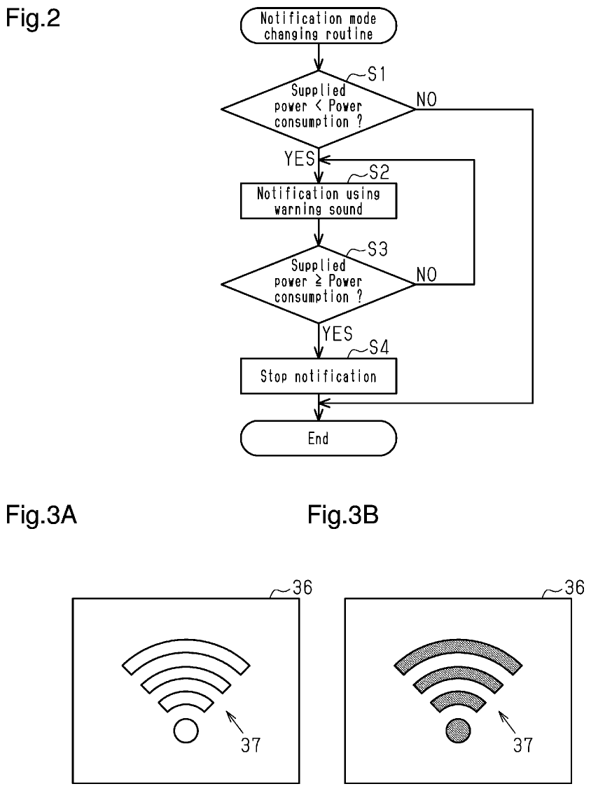

An electronic device 20 according to a first embodiment will now be described with reference to FIGS. 1 and 2.

Referring to FIG. 1, the electronic device 20 can be worn or carried. The electronic device 20 is activated by the power supplied in a wireless manner. Examples of the electronic device 20 include a smartphone and a wearable terminal.

The electronic device 20 includes a power receiving device 21, a reception-side power storage unit 31, a drive unit 32, and a notification unit. The power receiving device 21 is a part of a contactless power supply system 10 that performs contactless power supply using a power transfer signal.

The reception-side power storage unit 31 is a power source of the power receiving device 21 and the drive unit 32. The power capacity of the reception-side power storage unit 31 when fully charged is set to, for example, a power capacity that allows the power receiving device 21 and the drive unit 32 to be sufficiently supplied with power. Examples of the reception-side power storage unit 31 include a rechargeable battery (e.g., a lithium-ion rechargeable battery) or a capacitor. The reception-side power storage unit 31 stores some of or all of the power that has been converted by a reception-side conversion unit 24, which will be described later.

The reception-side power storage unit 31 includes a battery management system (BMS), which is not shown in the drawings. The BMS is configured to obtain information related to the state of charge (SOC) of the reception-side power storage unit 31. The state of charge includes the capacity of the amount of power (remaining battery level) left in the reception-side power storage unit 31. The reception-side power storage unit 31 includes a second power measurement unit 33 that measures power consumption. The power consumption refers to the power consumed by the power receiving device 21 and the drive unit 32.

The drive unit 32 may be an electronic circuit configured to enable the functions of the electronic device 20. Examples of the functions of the electronic device 20 may include a function of measuring temperature, humidity, user's body temperature, heart rate, blood pressure, and the like, a function of taking a still image or a video, a GPS function, and a function of showing various types of information on a display. The second power measurement unit 33 includes a current measurement circuit and a voltage measurement circuit. The second power measurement unit 33 obtains the power consumption by multiplying the current measured by the current measurement circuit by the voltage measured by the voltage measurement circuit.

The notification unit is used to notify the user of the state of power in the reception-side power storage unit 31. The notification unit is a sound generator 35 that produces a warning sound. In the first embodiment, the sound generator 35 is a buzzer that produces a single warning sound. In the electronic device 20, the sound generator 35 is located at a position where a warning sound can be emitted outward.

### Configuration of Contactless Power Supply System 10

The contactless power supply system 10 includes one or more power receiving devices 21. The contactless power supply system 10 includes a power transmitting device 11 in addition to the power receiving device 21. The power transfer signal used in the contactless power supply system 10 is transmitted, as a wireless signal, from the power transmitting device 11 to the power receiving device 21. The power transfer signal includes microwaves. Microwaves are electromagnetic waves each having a wavelength from 1 mm to 1 m (300 MHz to 300 GHz).

The wireless power transfer method (contactless power transfer method) employed in the contactless power supply system 10 is not limited to a microwave method. Instead, the wireless power transfer method may be an electromagnetic induction method, a magnetic field resonance method, an electric field resonance method, or a method using laser or the like.

In order to properly transmit a power transmission signal to the power receiving device 21, the power transmitting device 11 is required to properly set the phase of the power transfer signal, which will be transmitted, based on the orientation of the power receiving device 21 relative to the power transmitting device 11 and the distance to the power receiving device 21. Accordingly, the power receiving device 21 transmits a beacon signal including phase change information to the power transmitting device 11, which is requested by the power receiving device 21 to supply power, at a predetermined time interval. Based on the phase change information contained in the beacon signal received from the power receiving device 21, the power transmitting device 11 supplies the power receiving device 21 with power.

### Configuration of Power Transmitting Device 11

The power transmitting device 11 includes a power transmitting antenna 12, a transmission-side conversion unit 13, a transmission-side communication unit 15, and a transmission-side controlling unit 16.

The power transmitting antenna 12 is used for various types of communication with the power receiving device 21. The power transmitting antenna 12 is shared between, for example, communication related to a power transfer signal, communication related to a beacon signal, and information communication related to transmission and reception of various types of information.

To supply the power receiving device 21 with power, the transmission-side conversion unit 13 converts the power supplied from a power source 14 into a power transfer signal, and transmits the signal to the power transmitting antenna 12.

The transmission-side communication unit 15 performs various types of control related to communication with the power receiving device 21. For example, the transmission-side communication unit 15 controls the power transmitting antenna 12 so as to receive a beacon signal transmitted by the power receiving device 21 and transmit and receive various types of information to and from the power receiving device 21. The information communication related to the transmission and reception of the various types of information is enabled through, for example, Bluetooth®, Wi-Fi, or ZigBee®.

The transmission-side controlling unit 16 controls each component of the power transmitting device 11. The transmission-side controlling unit 16 may be, for example, circuitry including a hardware processor such as a central processing unit (CPU) configured to execute a computer program (software). Some of or all of the components of the circuitry may be provided by hardware such as a large scale integration (LSI), an application specific integrated circuit (ASIC), a field-programmable gate array (FPGA), or a graphics processing unit (GPU), or may be provided through cooperation of software and hardware. The computer program may be stored in advance in a hard disk drive (HDD) of the power transmitting device 11 or a storage device (not shown) that includes a non-transitory storage medium such as a flash memory.

The transmission-side controlling unit 16 adjusts the phase of the power transmitting antenna 12 based on, for example, a beacon signal received by the transmission-side communication unit 15. The transmission-side controlling unit 16 can also control (adjust) transmitted power by, for example, controlling the power transmitting antenna 12. The transmitted power may be adjusted by controlling the transmission-side conversion unit 13 to adjust the power received by the power transmitting antenna 12.

### Configuration of Power Receiving Device 21

As described above, the power receiving device 21 is a part of the electronic device 20 and a part of the contactless power supply system 10. The power receiving device 21 includes a power receiving antenna 22, a reception-side communication unit 23, a reception-side conversion unit 24, and a reception-side controlling unit 26.

The power receiving antenna 22 is used for various types of communication with the power transmitting device 11. The power receiving antenna 22 is shared between, for example, communication related to a power transfer signal, communication related to a beacon signal, and information communication related to transmission and reception of various types of information.

The reception-side communication unit 23 performs various types of control related to communication with the power transmitting device 11. For example, the reception-side communication unit 23 controls the power receiving antenna 22 so as to transmit a beacon signal to the power transmitting device 11 and transmit and receive various types of information to and from the power transmitting device 11.

The reception-side conversion unit 24 converts the power transfer signal received by the power receiving antenna 22 into DC power. The reception-side conversion unit 24 may be of any type. The reception-side conversion unit 24 includes, for example, a rectifying circuit and a smoothing circuit.

The reception-side conversion unit 24 includes a first power measurement unit 25 that measures supplied power. The supplied power refers to the power suppliable from the reception-side power storage unit 31 to the power receiving device 21 and the drive unit 32. The supplied power includes power supplied from the reception-side conversion unit 24 to the reception-side power storage unit 31. In the first embodiment, the first power measurement unit 25 measures, as the supplied power, the power supplied from the reception-side conversion unit 24 to the reception-side power storage unit 31.

The first power measurement unit 25 includes a current measurement circuit and a voltage measurement circuit. The first power measurement unit 25 obtains the supplied power by multiplying the current measured by the current measurement circuit by the voltage measured by the voltage measurement circuit.

The reception-side controlling unit 26 has a configuration similar to that of the transmission-side controlling unit 16. That is, the reception-side controlling unit 26 may be circuitry including a hardware processor such as a central processing unit (CPU) configured to execute a computer program (software). The reception-side controlling unit 26 controls the components of the power receiving device 21. Further, the reception-side controlling unit 26 includes a notification controlling unit 27 that controls the sound generator 35. That is, the notification controlling unit 27 may be circuitry including a hardware processor such as a CPU configured to execute a computer program (software). The notification controlling unit 27 is configured to obtain information related to the supplied power measured by the first power measurement unit 25 and the power consumption measured by the second power measurement unit 33. Based on the relationship between the obtained supplied power and power consumption, the notification controlling unit 27 changes a sound producing mode in the sound generator 35 from a first notification mode to a second notification mode or, oppositely, from the second notification mode to the first notification mode. In the first embodiment, the notification unit includes the sound generator 35. Thus, the notification mode is to produce and stop a warning sound. The mode of producing a warning sound corresponds to the first notification mode. The mode of stopping a warning sound corresponds to the second notification mode.

### Operation Flow

The flowchart of FIG. 2 illustrates a notification mode changing routine in which the notification controlling unit 27 changes the sound producing mode of the sound generator 35. While the electronic device 20 is operating, the routine is repeatedly executed in a predetermined control cycle, for example, each time a predetermined time has passed.

After starting the routine, in step S1, the notification controlling unit 27 first obtains information indicating the supplied power and information indicating the power consumption. The notification controlling unit 27 refers to both of the obtained information to determine whether the supplied power is less than the power consumption.

When the determination condition of step S1 is not satisfied, the notification mode changing routine is ended. In this case, the sound generator 35 produces no warning sound.

When the determination condition of step S1 is satisfied, the process is advanced to step S2. In step S2, the sound generator 35 is activated so as to produce a warning sound. The warning sound notifies the user that the supplied power becomes lower and the power receiving device 21 and the drive unit 32 are more likely to stop.

Subsequently, it is determined in step S3 whether the supplied power is greater than or equal to the power consumption. That is, it is determined whether the determination condition of step S1 is no longer satisfied because the user who heard the warning sound improved the power supply performance by adjusting the orientation of the electronic device 20 or moving the electronic device 20 toward the power transmitting device 11.

When the determination condition of step S3 is not satisfied, that is, when the supplied power is still less than the power consumption, the process is returned to step S2. Thus, in this case, the warning sound continues to be produced.

When the determination condition of step S3 is satisfied, it is determined that the supplied power becomes larger and the power receiving device 21 and the drive unit 32 are less likely to stop. Then, the process is returned to step S4. In step S4, the sound generator 35 is halted so as to stop producing the warning sound.

After step S4 is executed, the notification mode changing routine is ended.

In the notification mode changing routine, the process that produces no warning sound in the case where the determination condition of step S1 is not satisfied and the process that produces a warning sound in the case where that condition is satisfied (step S2) correspond to a process that changes a warning sound producing mode (notification mode).

The operation of the first embodiment will now be described. The advantages resulting from the operation will also be described.

(1) Referring to FIG. 1, the power transmitted from the power transmitting device 11 through contactless power supply is received by the power receiving device 21 and stored in the reception-side power storage unit 31. The power receiving device 21 and the drive unit 32 are activated by the power stored in the reception-side power storage unit 31. The activation of the power receiving device 21 and the drive unit 32 consumes power.

A user who possesses or carries the electronic device 20 is unable to see a power transfer signal (radio wave) transmitted from the power transmitting device 11 and thus cannot visually check the power transmissible region of the power transmitting device 11. This may cause the user to unknowingly go out of the power transmissible region of the power transmitting device 11.

When the electronic device 20 goes beyond the power transmissible region of the power transmitting device 11, the power supplied from the power receiving device 21 to the reception-side power storage unit 31 decreases. In an extreme case, the supplied power becomes 0 so that the power receiving device 21 and the drive unit 32 are more likely to stop unintentionally.

(1-1) In the first embodiment, the first power measurement unit 25 measures the power supplied from the power receiving device 21 to the reception-side power storage unit 31 as the supplied power, which is suppliable from the reception-side power storage unit 31 to the power receiving device 21 and the drive unit 32. The second power measurement unit 33 measures the power consumption, which is consumed by the power receiving device 21 and the drive unit 32.

The relationship between the supplied power measured by the first power measurement unit 25 and the power consumption measured by the second power measurement unit 33 is determined (step S1). When the supplied power is less than the power consumption, the sound generator 35 produces a warning sound (step S2). When the supplied power is greater than or equal to the power consumption, the sound generator 35 produces no warning sound.

Accordingly, the user checks whether the sound generator 35 is producing a warning sound so as to indirectly recognize the power transmissible region.

(1-2) When the user is in the process of moving the electronic device 20 beyond the power transmissible region, the warning sound producing mode can change. In this case, a warning sound can be produced. Accordingly, the user recognizes a change in the warning sound producing mode, that is, hears a warning sound so as to notice that he is beginning to move beyond the power transmissible region.

Additionally, when the user hears a warning sound or recognizes a change in the power transmissible region, the user recognizes whether the power receiving device 21 and the drive unit 32 are more likely to stop due to a shortage of supplied power.

(1-3) As described above, the warning sound producing mode is changed (i.e., a warning sound is produced or stopped) based on the relationship between the supplied power and the power consumption in the electronic device 20. Thus, the power transmissible region is set taking into account the following points in addition to the power supplying performance of the power transmitting device 11, and is thus more accurate.
Changes in distance from the power transmitting device 11 to the electronic device 20
Attenuation of power resulting from a change in the position of the electronic device 20 relative to an obstacle
Power consumption that differs between electronic devices 20

The power transmissible region is varied by these points and the like or by changes in the points. Accordingly, the user easily recognizes a change in the power transmissible region that occurs over time by, for example, changing the points.

(1-4) The sound generator 35 produces a warning sound. This allows the user to be audibly notified that the supplied power is less than the power consumption.

Particularly, in a case in which the electronic device 20 is frequently carried in a pocket, a bag, or the like, the notification using a warning sound allows the user to be effectively notified that the supplied power is less than the power consumption. Accordingly, the user notices a shortage of the supplied power without paying extra attention to the sound generator 35.

(1-5) The user recognizing a shortage of the supplied power can improve the power supplying performance by adjusting the orientation of the electronic device 20 or moving the electronic device 20 toward the power transmitting device 11. This increases the supplied power and thus eliminates the shortage of the supplied power. As a result, the user avoids an unexpected stop of the power receiving device 21 and the drive unit 32 that would result from the shortage of the supplied power.

At this time, the warning sound stops. This stop allows the user to be notified that the power receiving device 21 and the drive unit 32 avoid stopping, which would result from a decrease in the supplied power. In addition, since the warning sound that has been produced stops (i.e., the warning sound producing mode changes), the user recognizes the power transmissible region.

### Second Embodiment

The electronic device 20 according to a second embodiment will now be described with reference to FIGS. 1. 3A, 3B, and 4.

Referring to FIG. 1, the second embodiment is different from the first embodiment in that the notification unit includes an indicator 36 that generates visible light. The indicator 36 is located at a position of the electronic device 20 that can be visually checked by a user.

The indicator 36 includes a light-emitting element such as a light-emitting diode (LED). The indicator 36 includes, as a light source, a device configured to change the color of emitted light.

Based on the relationship between the supplied power and the power consumption, the notification controlling unit 27 changes a display mode in the indicator 36 from a first notification mode to a second notification mode or, oppositely, from the second notification mode to the first notification mode. The second embodiment, in which the notification unit includes the indicator 36, has two types of display modes shown in the indicator 36 as notification modes. FIG. 3A illustrates the first display mode, which corresponds to the first notification mode in the notification unit. FIG. 3B illustrates the second display mode, which corresponds to the second notification mode in the notification unit. The displaying in the first display mode is performed when the supplied power is less than the power consumption. The displaying in the second display mode is performed when the supplied power is greater than or equal to the power consumption. The displaying in the first display mode and the second display mode is shown using the same icon 37, which imitates a radio wave, and each have a different color of emitted light.

As described above, the notification unit is changed from the sound generator 35 to the indicator 36. Thus, the second embodiment is different from the first embodiment in the notification mode changing process in the notification unit by the notification controlling unit 27; that is, a display mode changing process in the indicator 36 in this case.

### Operation Flow

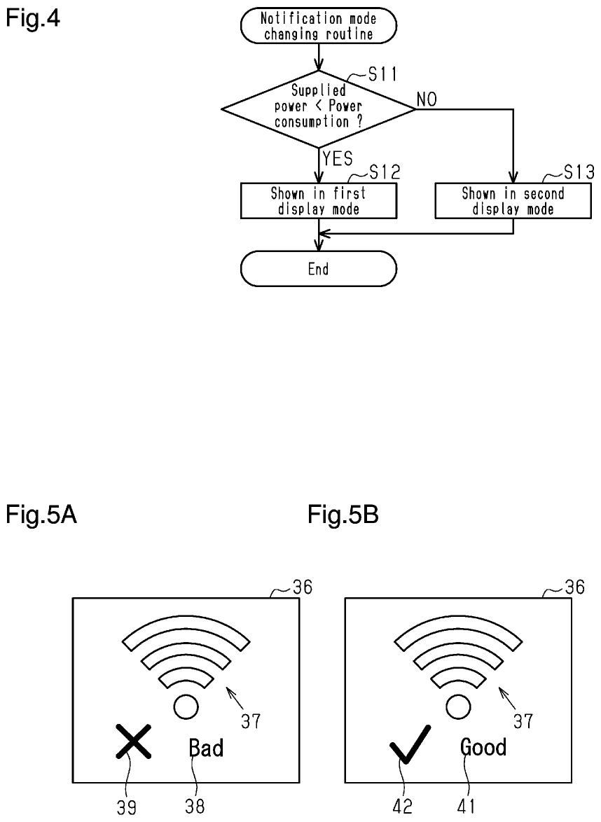

The flowchart of FIG. 4 illustrates a notification mode changing routine executed by the notification controlling unit 27. This flowchart corresponds to that of the first embodiment in FIG. 2.

After starting the routine, in step S11, the notification controlling unit 27 first executes the same process as that of step S1 of the first embodiment; that is, determines whether the supplied power is less than the power consumption.

When the determination condition of step S11 is satisfied, the process is advanced to step S12. In step S12, as shown in FIG. 3A, the notification controlling unit 27 causes the indicator 36 to be shown in the first display mode. The displaying in the first display mode notifies the user that the supplied power becomes lower and the power receiving device 21 and the drive unit 32 are more likely to stop.

When the determination condition of step S11 is not satisfied, the process is advanced to step S13. In step S13, as shown in FIG. 3B, the notification controlling unit 27 causes the indicator 36 to be shown in the second display mode. The displaying in the second display mode notifies the user that the supplied power is not insufficient and the power receiving device 21 and the drive unit 32 are less likely to stop.

After the process of step S12 or S13 is executed, the notification mode changing routine is ended.

In the notification mode changing routine, the processes of steps S11 to S13 correspond to a process that changes the display mode (notification mode) based on the relationship between the supplied power and the power consumption.

Accordingly, the second embodiment produces the same advantages as those of the first embodiment despite the difference from the first embodiment in the notification means (indicator 36) and the types of modes (display mode).

Particularly, the second embodiment allows the user to be visually notified of the relationship between the supplied power and the power consumption through the indicator 36.

Thus, the user sees the indicator 36 to check the display mode. This allows the user to indirectly recognize the power transmissible region. The user sees the indicator 36 so as to recognize whether the electronic device 20 is located inside or outside the power transmissible region. In addition, the user will recognize whether the power receiving device 21 and the drive unit 32 are more likely to stop due to a shortage of the supplied power.

When the display mode of the indicator 36 is the first display mode, the user adjusts the orientation of the electronic device 20 or moves the electronic device 20 toward the power transmitting device 11 so as to switch the display mode to the second display mode. This improves the power supplying performance and thus increases the supplied power. Consequently, the power receiving device 21 and the drive unit 32 avoid stopping.

### Modifications

The above embodiments may be modified as follows. The above embodiments and the following modifications can be combined as long as the combined modifications remain technically consistent with each other.

### Modifications Related to Supplied Power and Power Consumption

The current measured by the current measurement circuit correlates with the voltage measured by the voltage measurement circuit. As long as the current is measured by the current measurement circuit, the voltage can be estimated to a certain extent even if the voltage is not measured by the voltage measurement circuit. This allows for estimation of the power (supplied power and power consumption) based on the current that has been measured and the voltage that will be estimated. In other words, the power measurement units (first power measurement unit 25 and second power measurement unit 33) can include only the current measurement circuit.

In the same manner, as long as the voltage is measured by the voltage measurement circuit, the current can be estimated to a certain extent even if the current is not measured by the current measurement circuit. This allows for estimation of the power (supplied power and power consumption) based on the voltage that has been measured and the current that will be estimated. In other words, the power measurement units (first power measurement unit 25 and second power measurement unit 33) can include only the voltage measurement circuit.

While the electronic device 20 is operating, the first power measurement unit 25 may constantly measure the supplied power or may measure the supplied power at a certain time interval.

In the same manner, while the electronic device 20 is operating, the second power measurement unit 33 may constantly measure the power consumption or may measure the power consumption at a certain time interval.

Modification Related to Relationship between Supplied Power and Power Consumption

The relationship between the supplied power and the power consumption may be determined by comparing the deviation between the supplied power and the power consumption with one or more threshold values.

If this determination is performed using one threshold value, the notification mode in the notification unit may potentially be often switched by variations in the deviation around the threshold value. This may occur when either the sound generator 35 or the indicator 36 is used as the notification unit.

To solve this problem, a control hysteresis may be set. That is, threshold values, namely, a first threshold value and a second threshold value, which is greater than the first threshold value, may be set.

In this case, when the deviation increases to exceed the second threshold value, the notification mode changes from the first notification mode to the second notification mode. When the deviation decreases to fall below the first threshold value, the second notification mode returns to the first notification mode. This configuration prevents the notification mode from being switched often.

The first threshold value and the second threshold value may be predefined values (fixed values). Instead, the first threshold value and the second threshold value may be generated based on the supplied power or power consumption during execution of the notification mode changing routine. In this case, the first threshold value and the second threshold value are variable values. For example, the use of variable values is effective when variations occur in the supplied power obtained by converting a power transfer signal.

### Modification Related to Notification in Notification Unit

The condition that the sound generator 35 produces a warning sound may additionally include a condition in which the electronic device 20 is located in the power transmissible region; that is, a condition in which the power receiving device 21 is receiving power from the power transmitting device 11.

This is because the power receiving device 21 is normally supplied with no power if the electronic device 20 is not located in the power transmissible region.

### Modification Related to Change in Notification Mode

When the relationship between the supplied power and the power consumption changes so that the notification mode in the notification unit is altered, notification in that notification mode may be maintained regardless of the change in the relationship until a certain time has elapsed since that change. In this modification, the notification unit includes the sound generator 35 and the indicator 36. This configuration prevents the notification mode from being switched often.

### Modifications Related to Sound Generator 35

The sound generator 35, which serves as the notification unit, may be a component of the power receiving device 21.

The sound generator 35 may be a speaker instead of a buzzer. In this case, notification may be made using a single sound or may be made using a synthesized sound (e.g., synthesized voice).

Unlike the first embodiment, the sound generator 35 may produce a sound even when the supplied power is greater than or equal to the power consumption. In this case, a sound is produced in a mode that differs from that when the supplied power is less than the power consumption.

In the first embodiment, the volume of a warning sound may be varied depending on the power (remaining battery level) left in the reception-side power storage unit 31. For example, as the power becomes smaller, the warning sound may become larger in a stepwise manner.

Alternatively, the type of a warning sound may be varied depending on the power (remaining battery level). Examples of the type of a warning sound include a continuous sound and an intermittent sound.

When the supplied power is less than the power consumption, the volume of a warning sound may be varied depending on the deviation between the supplied power and the power consumption. For example, as the deviation becomes larger, the warning sound may become larger in a stepwise manner.

The type of a warning sound may be varied depending on the deviation. Examples of the type of a warning sound include a continuous sound and an intermittent sound.

A warning sound may be produced when the average value of the supplied power over a certain period of time is less than the average value of the power consumption over the certain period of time as a result of the comparison between them.

There may be a means for forcibly stopping a warning sound. Examples of such a means include a power button and a stop button. A warning sound may be stopped by a user operating such a button.

A warning sound may be produced when the supplied power remains less than the power consumption for a certain period of time.

In the contactless power supply system 10, when power is transmitted from one power transmitting device 11 to multiple power receiving devices 21, the power is basically distributed equally in correspondence with the number of the power receiving devices 21. The power is transmitted to the power receiving devices 21 in equal proportions.

In such a circumstance, there is a possibility that a warning sound continues to be produced for a certain period of time only in a specific power receiving device 21. In this case, that power receiving device 21 may send, to the power transmitting device 11, a request signal including information that requests the power transmitting device 11 to supply a larger amount of power to that power receiving device 21 than to the other power receiving devices 21.

When the request signal is received by the power transmitting device 11, the power transmitting device 11 may distribute power to the power transmitting device 11 that sent the request signal in a larger proportion than the other power receiving devices 21. This modification allows the power receiving device 21 that sent the request signal to be supplied with a larger amount of power in a prioritized manner.

When the request signal cannot be received by the power transmitting device 11, the volume, type, or the like of a warning sound may be varied.

### Modifications Related to Indicator 36

The indicator 36, which serves as the notification unit, may be a component of the power receiving device 21.

In the second embodiment, the light source of the indicator 36 may be, for example, an incandescent lamp, a fluorescent lamp, or a laser light source.

The display mode in the indicator 36 may be changed to a display mode that differs from those in FIGS. 3A and 3B. FIGS. 5A and 5B each show an example. In the display mode of this modification, characters 38, 41 and marks 39, 42 are shown in addition to the icon 37 of FIGS. 3A and 3B. Specifically, in the first display mode, the indicator 36 shows the icon 37, which imitates a radio wave, the character 38 (“bad”), and the mark 39 (“x”) as illustrated in FIG. 5A. In the second display mode, the indicator 36 shows the icon 37, which imitates a radio wave, the character 41 (“good”), and the mark 42 (“1”) as illustrated in FIG. 5B.

Although not illustrated, at least one of the icon 37, the character 38, 41, or the mark 39, 42 may be different from that in FIGS. 5A and 5B.

Instead, the characters 38, 41 or the marks 39, 42 may be omitted from the combinations of the icon 37, the characters 38, 41, and the marks 39, 42.

Alternatively, the first display mode (FIG. 5A) may be different from the second display mode (FIG. 5B) in color.

Three display modes or more may be set depending on how the deviation between the supplied power and the power consumption is large. As the deviation changes, the display mode may be changed.

The second display mode does not have to be performed as shown in FIGS. 3B and 5B. Instead, in the second display mode, the light source may be turned off to stop displaying (i.e., to show nothing).

The indicator 36 may show the arrangement of light-emitting elements. In this case, the light-emitting elements represent marks or the like. The types or the like of the displayed marks may be varied by changing a light emitting mode of the light-emitting elements (including whether light is emitted).

The indicator 36 may be a display (e.g., a liquid crystal display). In this case, a notification message, a notification image, or the like may be shown in the indicator (display) so that the user is notified of the relationship between the supplied power and the power consumption. Alternatively, no notification message, notification image, or the like may be shown in the indicator (display) so that the user is notified of the relationship between the supplied power and the power consumption.

When the supplied power is less than the power consumption, the display mode in the indicator 36 may be varied depending on the deviation between these powers. For example, as the deviation becomes larger, the notification message, notification image, or the like shown in the display may become more noticeable.

### Modifications Related to Other Features of Notification Unit

Instead of the sound generator 35 (first embodiment) and the indicator 36 (second embodiment), the notification unit may be a vibrator.

The vibrator vibrates using a vibration motor or the like as a vibration source. In this case, whether vibration occurs, the intensity of vibration, or the like allows the user to be tactilely notified of the relationship between the supplied power and the power consumption.

Thus, the user feels the vibration output from the vibration source to indirectly recognize the power transmissible region. By feeling the vibration, the user notices that the supplied power is insufficient and the power receiving device 21 and the drive unit 32 are more likely to stop. The user adjusts the orientation of the electronic device 20 or moves the electronic device 20 toward the power transmitting device 11 so as to stop the vibration, thereby avoiding situations in which the power receiving device 21 and the drive unit 32 stop.

Particularly, in the same manner as the above audible notification, in a case in which the electronic device 20 is frequently carried in a pocket, a bag, or the like, a vibration notification allows the user to be effectively notified that the supplied power is less than the power consumption. In this case, the user notices a shortage of the supplied power without paying extra attention to the notification unit (the vibrator in this case).

When the supplied power is less than the power consumption, the vibration mode in the vibrator may be varied depending on the deviation between these powers. For example, as the deviation becomes larger, the vibrator may be vibrated more strongly.

The notification unit may include at least one of the sound generator 35, the indicator 36, and the vibrator. Instead, the notification unit may be a combination of two or three of them.

### Modification Related to Notification Controlling Unit 27

The notification controlling unit 27 does not have to be disposed in the reception-side controlling unit 26 and may be disposed in a control device (not shown) that controls the drive unit 32. The notification controlling unit 27 may be used to obtain the supplied power from the first power measurement unit 25 and obtain the power consumption from the second power measurement unit 33 so as to determine the relationship between both powers.

### Modifications Related to Power Receiving Device 21

When multiple power receiving devices 21 are disposed, an upper limit may be set for the number of the power receiving devices 21. The upper limit may be set according to, for example, the power capable of being supplied by the power transmitting device 11.

In the first embodiment, when a warning sound is produced, that is, when the supplied power is insufficient, a beacon signal including phase change information does not need to be transmitted in a predetermined time interval. If a beacon signal is transmitted to the power receiving device 21 in the predetermined time interval, the transmission of the beacon signal consumes a larger amount of power.

To solve this problem, a relatively long transmission interval of a beacon signal may be set in a period during which a warning sound is produced. This modification reduces the power consumption caused by the transmission of a beacon signal.

In the second embodiment, since the supplied power is insufficient when the indicator 36 is shown in the first display mode, the transmission interval of a beacon signal may be changed in the same manner.

### Modification Related to Antennas

If information communication related to the transmission and reception of various types of information is frequently performed between the power transmitting device 11 and the power receiving device 21, the power transmitting antenna 12 and the power receiving antenna 22 may be incapable of properly transmitting and receiving a power transfer signal and a beacon signal to and from each other.

To solve this problem, the power transmitting device 11 and the power receiving device 21 may each include a separate antenna used for communication related to a power transfer signal, communication related to a beacon signal, and information communication related to the transmission and reception of various types of information. This limits situations in which one communication hinders another communication.

### Modification Related to Power Transmitting Device 11

Multiple contactless power supply system 10 may be coordinated with each other. With this coordination, each power transmitting device 11 may be supplied with power and activated by power transfer signals transmitted from the power transmitting devices 11 of the other contactless power supply systems 10.

### Other Modifications

In the first and second embodiments, the power supplied from the reception-side conversion unit 24 to the reception-side power storage unit 31 may be used as supplied power. Alternatively, that power may additionally include the power (remaining battery level) left in the reception-side power storage unit 31 so as to be used as supplied power. The power left in the reception-side power storage unit 31 can be obtained from the BMS of the reception-side power storage unit 31.

In this case, the first power measurement unit 25 obtains the supplied power by adding the power left in the reception-side power storage unit 31 to a product of the current measured by the current measurement circuit and the voltage measured by the voltage measurement circuit.

This modification allows the first power measurement unit 25 to measure, as the supplied power, the power that contains the power left in the reception-side power storage unit 31 in addition to the power supplied from the power receiving device 21 to the reception-side power storage unit 31. Thus, as compared with when only the power supplied from the power receiving device 21 to the reception-side power storage unit 31 is measured by the first power measurement unit 25 as the supplied power, the supplied power is measured more accurately.

Accordingly, in steps S1, S11 of the notification mode changing routine by the notification controlling unit 27, the possibility that the power receiving device 21 and the drive unit 32 stop operating due to a decrease in the supplied power is determined more accurately. This allows the sound generator 35 to produce a warning sound when the power receiving device 21 and the drive unit 32 are more likely to stop operating in the first embodiment. In the second embodiment, the indicator 36 is shown in the first display mode when the power receiving device 21 and the drive unit 32 are more likely to stop operating.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

1. An electronic device, comprising:
a power receiving device configured to receive power transmitted from a power transmitting device through contactless power supply using a power transfer signal;
a reception-side power storage unit configured to store the power received by the power receiving device;
a drive unit configured to be activated together with the power receiving device by the power stored in the reception-side power storage unit;
a notification unit configured to notify a user of a state of the power in the reception-side power storage unit;
a first power measurement unit configured to measure supplied power, the supplied power referring to power suppliable from the reception-side power storage unit to the power receiving device and the drive unit;
a second power measurement unit configured to measure power consumption, the power consumption referring to power consumed by the power receiving device and the drive unit; and
circuitry configured to change a notification mode in the notification unit based on a relationship between the supplied power measured by the first power measurement unit and the power consumption measured by the second power measurement unit.

2. The electronic device according to claim 1, wherein the supplied power includes power supplied from the power receiving device to the reception-side power storage unit.

3. The electronic device according to claim 2, wherein the supplied power further includes power left in the reception-side power storage unit.

4. The electronic device according to claim 1, wherein
the notification unit includes a sound generator configured to produce a warning sound, and
the circuitry is configured to cause the sound generator to produce the warning sound on condition that the supplied power is less than the power consumption.

5. The electronic device according to claim 4, wherein the circuitry is configured to cause the sound generator to stop producing the warning sound when the supplied power becomes greater than or equal to the power consumption while the sound generator is producing the warning sound.

6. The electronic device according to claim 1, wherein
the notification unit includes an indicator configured to be shown in a first display mode and a second display mode, and
the circuitry is configured to cause the indicator to be shown in the first display mode when the supplied power is less than the power consumption and cause the indicator to be shown in the second display mode when the supplied power is greater than or equal to the power consumption.
